(19) United States
(12) Patent Application Publication
(10) Pub. No.: US 2007/0209607 A1
(43) Pub. Date: Sep. 13, 2007

(54) Fuel additive injection system

(75) Inventors: Gary E. Williams, Montgomery, TX (US); Nicola J. Palozzi, Toronto (CA)

Correspondence Address: IP SECTION;GARDERE WYNNE SEWELL LLP, 3000 THANKSGIVING TOWER, 1601 ELM STREET, SUITE 3000, DALLAS, TX, 75201, US

(73) Assignee: CHEMTEC ENERGY SERVICES, INC., WILLIS, TX (US)

(21) Appl. No.: 11/657,841

(22) Filed: Jan. 25, 2007

Related U.S. Application Data
(60) Provisional application No. 60/763,344, filed on Jan. 30, 2006.

(51) Int. Cl. F02B 43/00; F02B 23/00; F02B 47/00

(52) U.S. Cl. 123/1 A; 123/585

(57) ABSTRACT

A fuel additive injection system includes a fluid additive supply tank, a fluid additive quantity sensor, a flowmeter, remotely controllable valves and a controller including a microcontroller, a visual display and a keypad interface for establishing operation of the system to blend or inject a fuel additive for an internal combustion engine on a vehicle or a stationary apparatus. A quantity of a particular fuel additive to be injected may be selected based on a predetermined amount of fuel added to one or more fuel tanks. The system may keep records of fuel consumption and may utilize pressure air from a source driven by an engine or additive may be injected utilizing a motor driven pump as part of the additive injection system.

### CROSS REFERENCE TO RELATED APPLICATION

This application claims the benefit of provisional application No. 60/763,344, filed Jan. 30, 2006, which is incorporated herein by reference.

### BACKGROUND OF THE INVENTION

The continued increase in the cost of hydrocarbon fuels for transportation and other applications, together with environmental considerations, has given rise to the need for the use of various chemical additives in the fuel. Depending on environmental considerations and regulations, the climate in which an internal combustion engine will operate and the engine performance requirements, the need for the use of a specialized chemical additive may vary with the engine application. Thus, the doping of large volumes of fuel with a particular additive may not satisfy the needs of certain applications of the fuel. Accordingly, it has become increasingly desirable and necessary to provide a fuel additive injection system which may be carried onboard a hydrocarbon fuel powered vehicle and may be associated with stationary engine applications as well.

One significant application for which an onboard fuel additive injection system is necessary and desirable is for motor vehicles, including long and short haul motor trucks. It is desirable to place a fuel additive injection system onboard a motor truck, for example, and which may be managed by the user or driver of the vehicle to provide additive injection into the fuel in the vehicle fuel tanks and provide user control over such injection, as well as certain data acquisition. Energy for operation of the additive injection system may be based on pressure air available onboard the vehicle or using available electrical power. It is to satisfy the desiderata and requirements for fuel additive injection systems of the general type mentioned hereinabove that the present invention has been developed.

### SUMMARY OF THE INVENTION

The present invention provides a fuel additive injection system, particularly of a type which may be disposed onboard a motor vehicle, including, more particularly, over-the-road motor trucks.

The fuel additive injection system of the invention may be a self-contained additive dispensing apparatus capable of controlling the addition of one of several types of fuel additives, including catalytic type additives, directly into the fuel tanks.

In accordance with certain aspects of the invention, the additive injection system may be used for injecting an additive into selected fuel tanks onboard a vehicle, such as the so-called saddle type fuel tanks of a motor truck. Still further, the additive injection system of the invention provides apparatus for human interfacing with the system for programming, access to statistics, control and operation of the system.

Still further, the invention contemplates the provision of a fuel additive injection system which will provide a transaction log to track and record operation, performance and onboard calculation and display of fuel consumption parameters.

In accordance with a further aspect of the invention, an additive injection system is provided for motor vehicle applications which is operable to perform calculations for various fuel volumes, distances traveled and different units of measure of distance and volume.

The invention further contemplates a system which provides certain optional recording and transmission of information including support for recording of transaction data on a multimedia smart card for remote data analysis and for wireless transmission of data for remote analysis.

The invention further provides an improved method of adding a fuel additive to a fuel tank or tanks for an internal combustion engine.

Those skilled in the art will further appreciate the advantages and superior features of the additive injection system of the present invention based on the following description and diagrams.

### BRIEF DESCRIPTION OF DRAWINGS

FIG. 1 is a schematic diagram of a fuel additive injection system in accordance with the invention; and

FIGS. 2A through 2H comprise flow diagrams of certain features in the operation of the additive injection system of the invention.

### DESCRIPTION OF A PREFERRED EMBODIMENT

In the description which follows, like elements are marked throughout the specification and drawing with the same reference numerals, respectively. The drawing figures are not to scale and certain features may be shown in schematic form in the interest of clarity and conciseness.

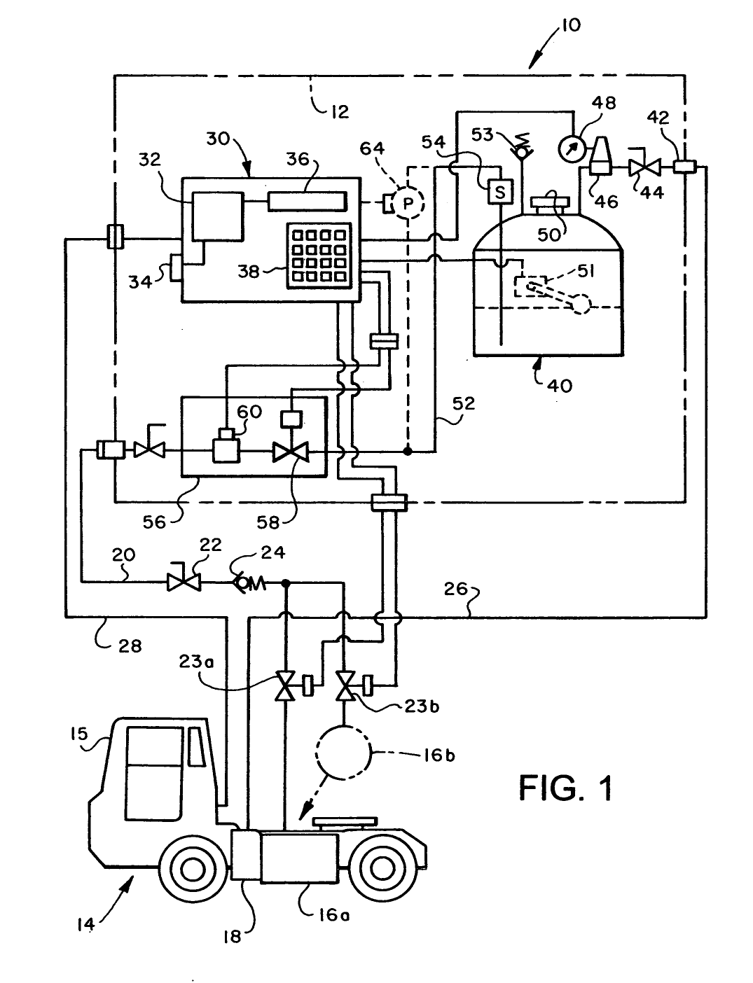

Referring to FIG. 1, the additive dispensing or injection system in accordance with the present invention is illustrated schematically and generally designated by the numeral 10. The system 10 may be substantially contained within an enclosure 12 although the components of the system 10 to be described may be disposed in locations other than within a single enclosure. The system 10 is particularly adapted for use in conjunction with an over the road motor truck 14 having one or more fuel tanks, such as opposed, so called “saddle” tanks 16a and 16b, a conventional twelve volt DC electrical system, not illustrated, and a source of pressure air, such as would be used for a vehicle brake system, said source of pressure air including a reservoir or tank 18.

The additive injection system 10 is thus adapted to be connected to the tanks 16a and 16b via a flexible or rigid conduit system 20 for dispensing fuel additives into the tanks. A manually actuatable shut-off or isolation valve 22 and a check valve 24 are interposed in conduit system 20 between the system enclosure 12 and the tanks 16a and 16b. Remotely controllable valves 23a and 23b may also be interposed in conduit system 20, as shown. The system 10 is also operably connected to the source of pressure air 18 by way of a flexible or rigid conduit 26 and suitable electrical conductor means 28 may be provided for connection to the vehicle electrical system to provide a source of electric power to the additive injection system 10.

Referring further to FIG. 1, the additive injection system 10 is also characterized by a controller unit 30 including a microcontroller 32 provided with electrical power by way of the conductor 28 and which power is suitably modified for use by system 10. The microcontroller 32 may be of a type commercially available such as a Zilog ZA Encore Model including 64K bytes of flash program memory, 4K bytes register area and a suitable set of peripheral interfaces. A battery back-up powered calendar clock may be provided by a RAM tron microprocessor companion chip. Additional non-volatile memory may be provided by additional serial memory chips. An optional multi-media storage card may be interfaced using a synchronous serial communications interface. Communication with outside equipment may be carried out by way of an RS232 communications port, generally designated by the numeral 34. In order for the controller 30 to process high-speed pulse information from a high resolution flow meter, two counter timers may be used to count and accumulate flow meter pulses until the processor or microcontroller 32 is able to schedule an appropriate task. A two-line, 24 character alphanumeric display 36 is operably associated with microcontroller 32 as is a user or operator interface comprising a sixteen key keypad 38 including keys for numerals 0-9, a point, a dash and keys marked Enter, Clear, Start and Stop. Keypad 38 is used for data and command entry and the display 36 will display all operator messages and performance data. The enclosure 12 may be mounted in cab 15 of motor truck 14, FIG. 1, or elsewhere on board the vehicle.

As further shown in FIG. 1, the system 10 includes an additive storage pressure vessel or tank 40 in communication with a source of pressurizing air including the conduit 26, by way of a connector 42, a manual shut-off or isolation valve 44 and a suitable pressure regulator 46 including a regulator pressure gauge and signal transmitting sensor 48. Tank 40 includes an additive filler neck and pressure cover or cap 50 to provide an access point for loading a fluid fuel additive into the system 10. Additive is dispensed from the tank 40 by way of a conduit 52 including a suitable filter or strainer 54 interposed therein. A liquid additive quantity sensor 51 is associated with tank 40 and transmits a suitable signal to controller unit 30. Conduit 52 leads to a so-called injector module 56 including a solenoid operated shut-off valve 58 operably connected to the controller unit 30 together with a flowmeter 60. Flowmeter 60 may be of a type commercially available. Moreover, the displacement of additive from the tank 40 may also be carried out using a motor-driven pump 64 instead of pressurizing the tank 40 utilizing pressure air from on board the truck or vehicle 14. Pump 64, FIG. 1, may be controlled by the controller 30 and furnished with electric power by way of the controller and the vehicle electrical system. In this way, the system 10 may be adapted for use with motor trucks and other vehicles and other applications which do not have an onboard supply of pressure air.

The controller 30 may be programmed by way of its microcontroller 32 to carry out various advantageous processes in accordance with the invention. As previously described, the fuel additive injection system 10 is a substantially self-contained dispenser operable to control the addition of a selected quantity of additive into the fuel supply tank or tanks for a vehicle or other engine driven apparatus. Although the system 10 includes features which are advantageous, in particular, for over-the-road motor trucks it may also be used for various other applications, including stationary applications, marine applications, and virtually all applications wherein a measured quantity of fuel additive is required to be added to the fuel supply system for an internal combustion engine. The system 10 may provide for onboard calculation and display of fuel consumption per unit of distance traveled, for example, units of measure such as in United States miles and U.S. gallons, and such units may be converted to other units. The system 10 may be adapted for recording of transaction data on a medium such as a multi-media smart card, SD cards, and the like, for remote data analysis. Still further, the system 10 may support wireless transmission of data for remote analysis.

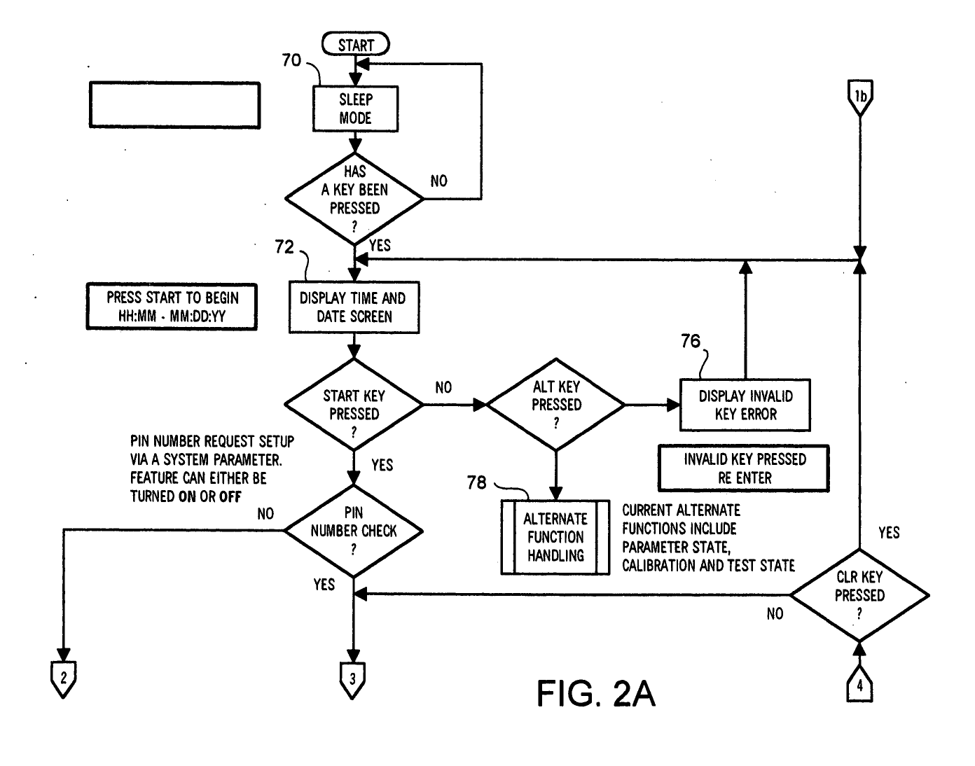

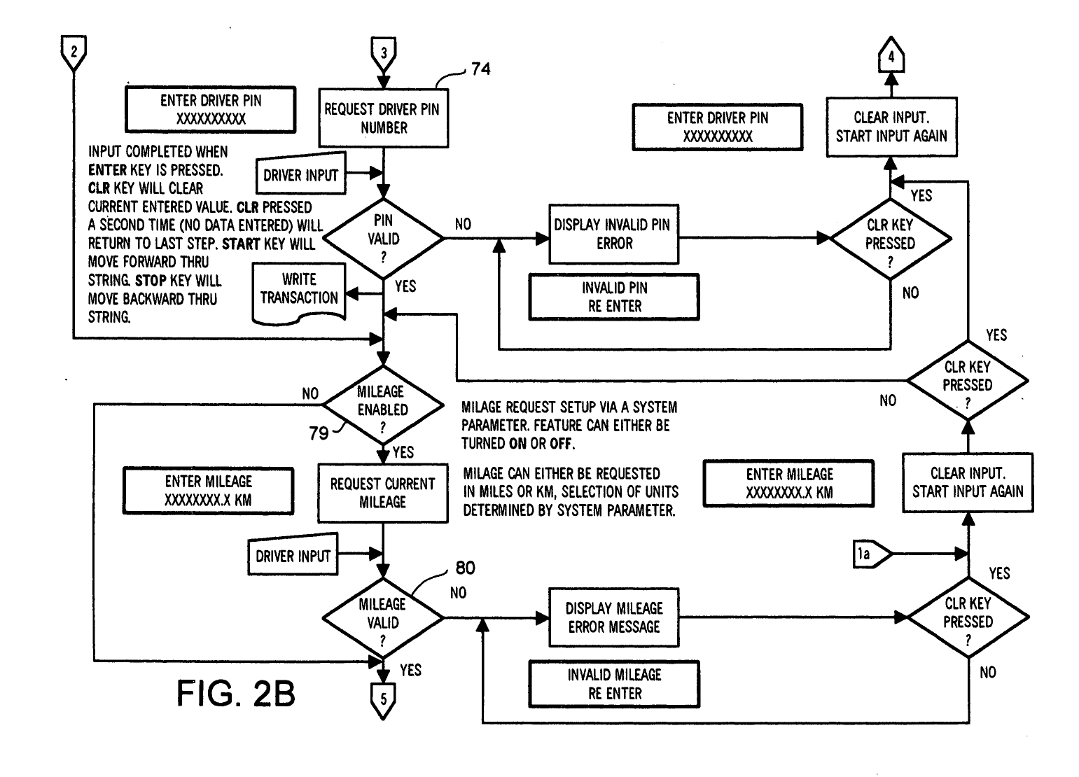

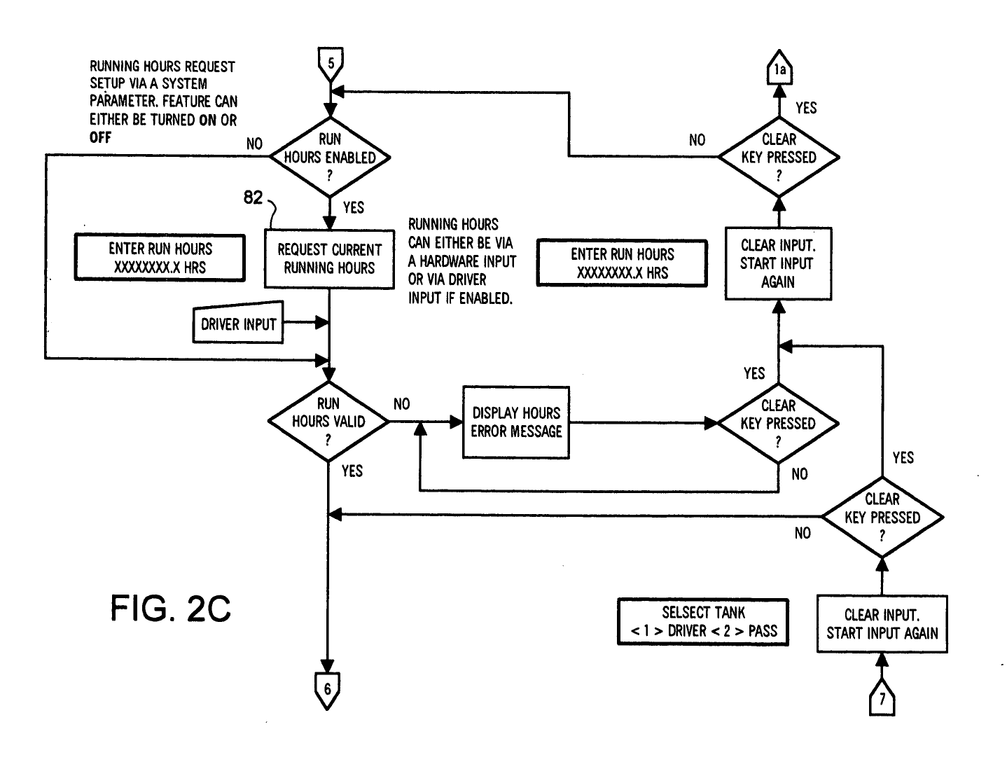

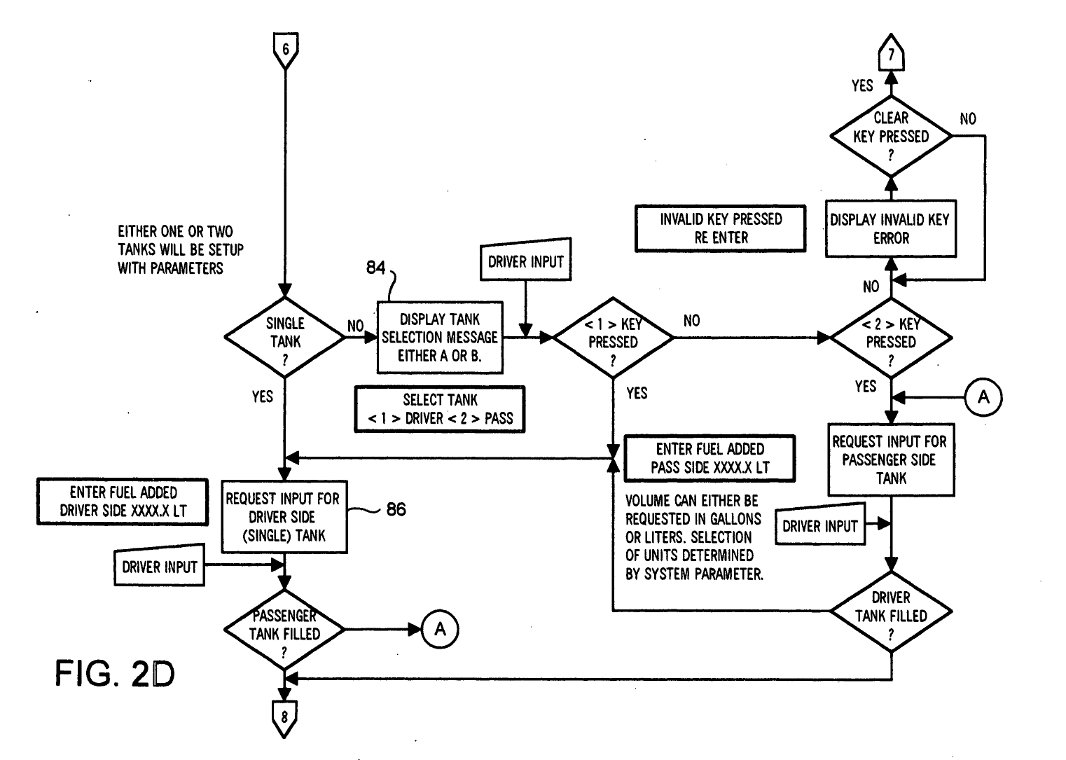

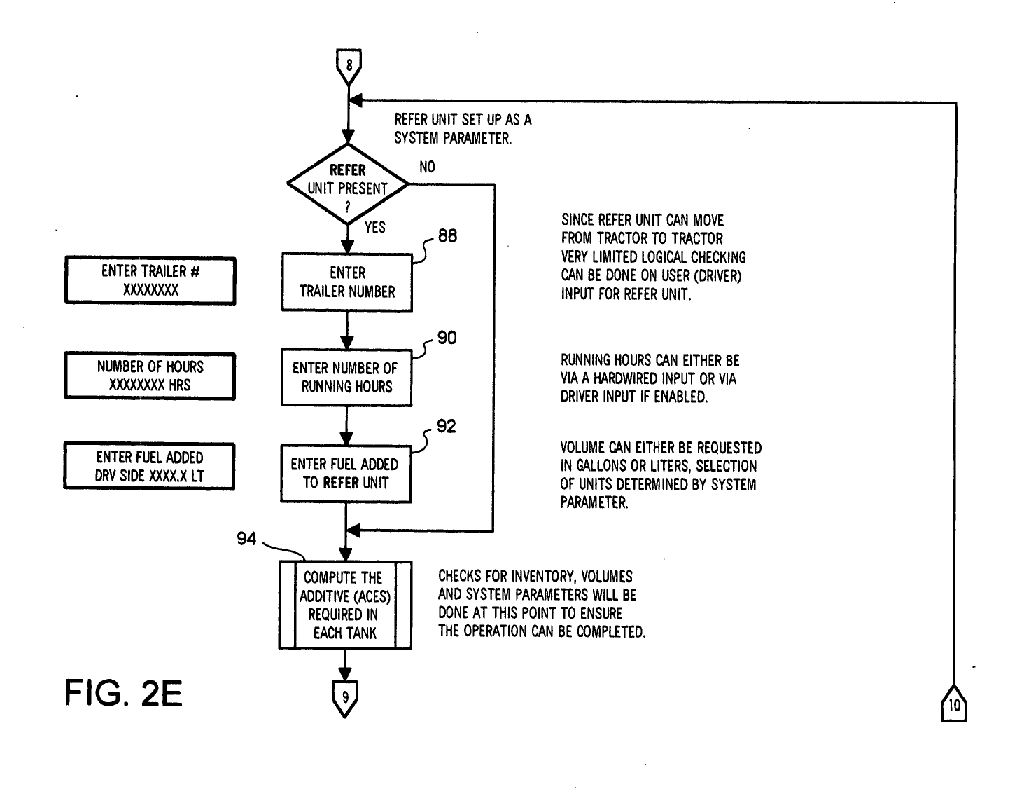

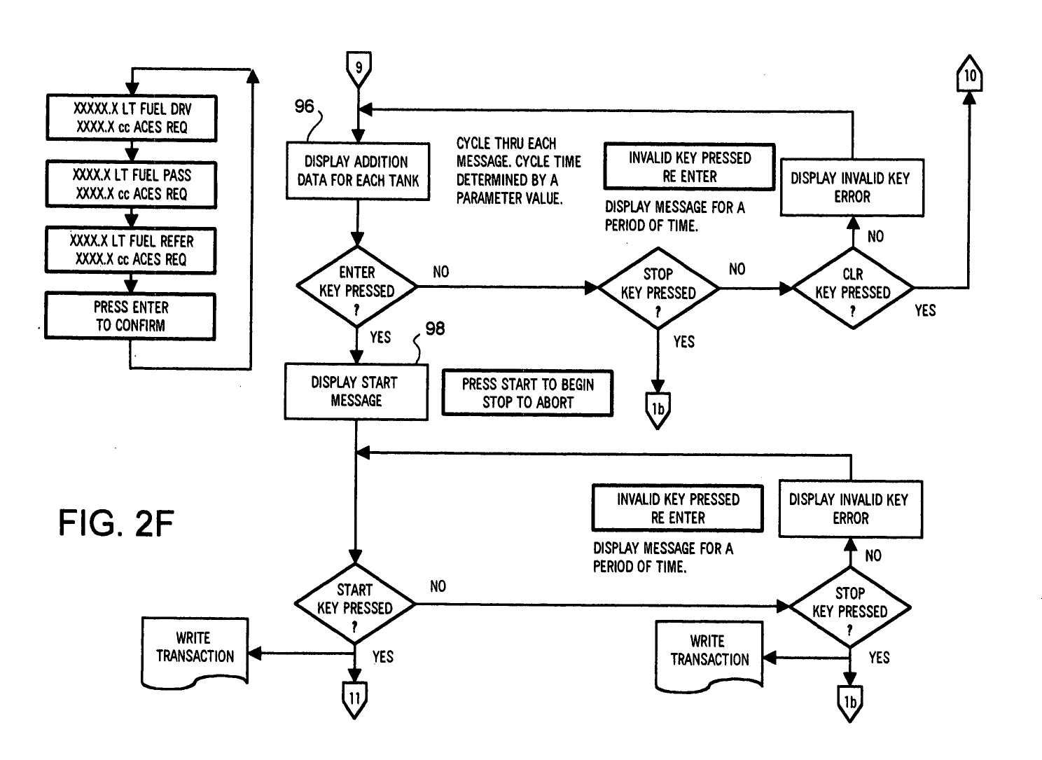

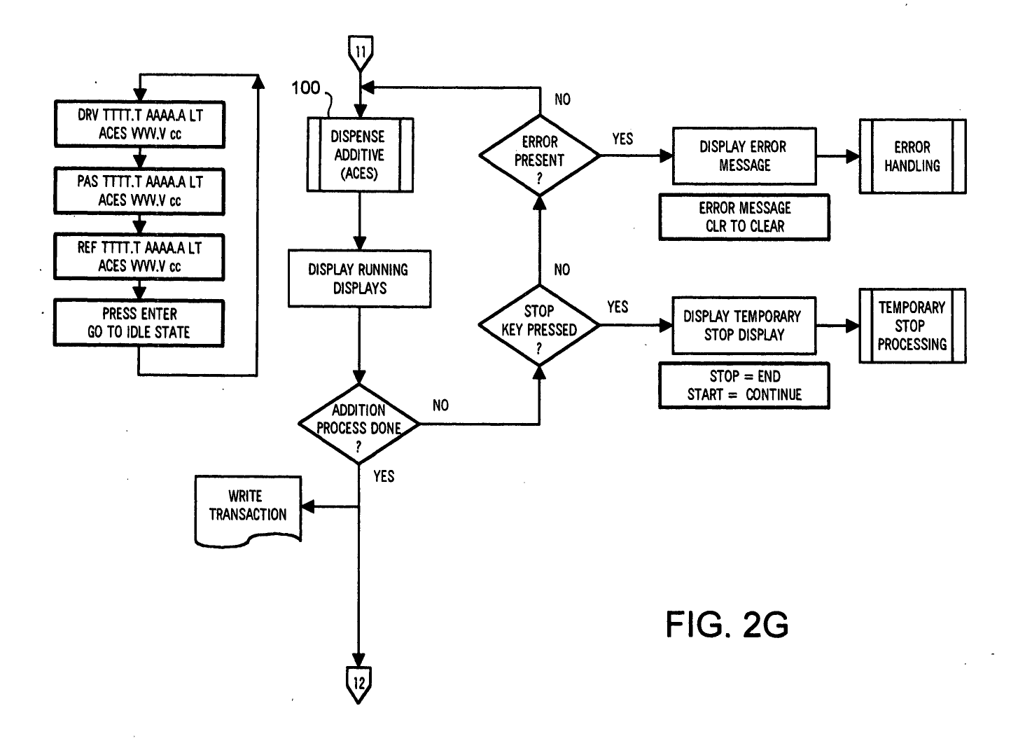

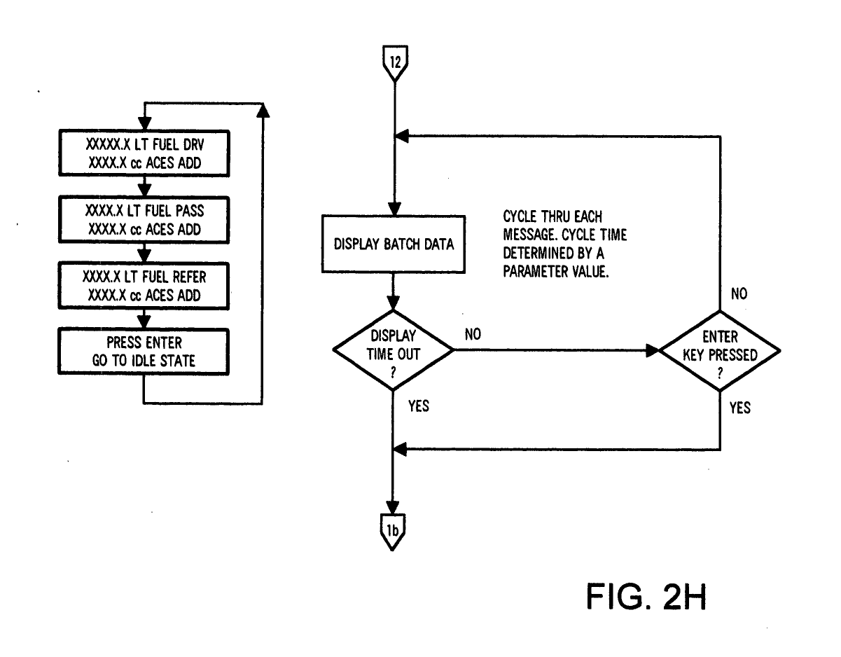

The controller 30 for the system 10 may reside in one of several conditions or states such as an idle state, operate state, calibration state, emergency state, statistics/parameter state, a data entry state, a temporary stop state, and a diagnostic state. FIGS. 2A through 2H are diagrams indicating at least part of a typical operating sequence for the system 10 and operation of the system 10 may be carried out as indicated in FIGS. 2A through 2H. The steps in a process according to the invention are described in FIGS. 2A through 2H and are believed to be self-explanatory based on the descriptions set forth in the diagrams of the drawing figures. However, briefly, referring to FIGS. 2A and 2B, for example, if the controller 30 is in an idle or sleep mode as indicated by the condition 70, it will remain in such a mode unless one of the keys of the keyboard or keypad 38 is pressed. If a so-called start key is pressed, the display 36 will display time and date at step 72. If the start key has been pressed, the system will proceed to request that the operator, such as a motor truck driver, enter a personal identification number or (PIN) at step 74. If an alternate key is pressed, either an invalid key error is displayed at step 76 or, if a valid alternate function is initiated, the system 10 will proceed to same at step 78. If a valid PIN number is entered and, for example, a mileage step is enabled at 79, the current mileage can be entered at step 80, that is vehicle miles traveled as read from an odometer onboard the vehicle, for example.

Referring now to FIGS. 2C and 2D, the number of engine running hours may be entered in the controller at step 82 and, if the hours indicated are valid, the program will prompt the operator of the controller 30 to select either one of two tanks, if provided, FIG. 2D, and then request the operator to enter the quantity of fuel added to the tank selected via steps 84 and 86, for example.

The fuel additive injection system 10 may be adapted for use with specialized vehicles including motor trucks which have a separate refrigeration (REFER) apparatus for maintaining a predetermined temperature in the truck or trailer body. As shown in FIGS. 2E and 2F, steps are provided for entering information into the controller 30 regarding a trailer identification number indicated at step 88, the number of running hours for the refrigeration unit at step 90 and the quantity of fuel added to the fuel tank for the engine driven refrigeration unit at step 92. At steps 94 and 96, the system 10 will compute the quantify of fuel additive required in each tank and display such data at step 96, FIG. 2F. Fuel additive is then added by pressing the aforementioned start key of the key pad 38, as indicated in the diagram of FIGS. 2E and 2F and wherein the display 36 will display the start message at step 98. As shown in FIGS. 2G and 2H the controller 30 will dispense the required additive to the appropriate tank as indicated at step 100, FIG. 2G. Additional steps in a procedure for operating the system 10 are believed to be self explanatory from the descriptions provided in FIGS. 2A through 2H.

While the controller 30 is in the idle state of the system 10, it will monitor all of the inputs and the keypad 38. While in the idle state, the system 10 may also measure a number of error conditions such as monitoring signals from the flowmeter 60. If an error occurs, such as unauthorized flow is detected which may be caused by leaking control valves, such as the valve 58, the system may enter the emergency state.

When the system 10 is enabled, it leaves the idle state and enters the data entry state, previously described partially, and when all required data has been entered into the system it may then automatically enter an operator dispensing state. In the data entry state, the system will display, on a top line of the display 36, data that is to be entered and the bottom line of the display will show the value of the data being entered as well as the units of the data. At any time during data entry, pressing a Clear key on the keypad 38 will cause data that has been entered to be cleared and the previous data entered to be shown. The system may ask for verification that the correct data has been entered by requiring that the data be entered a second time.

Data may be entered for vehicle odometer reading, volume (quantity) of fuel added and volume of additive being entered. A sequence of prompts, such as indicated in FIGS. 2A through 2H along the left side of the diagrams, may be displayed for each parameter to be entered. While the system 10 is in the data entry state of the controller 30, data entry error messages can be generated and displayed, such as “value not in range, value below limit, value above limit, too many characters, integer only, miles per gallon (MPG), and not logical”. Error correction or recovery may be made by reentering the correct data or canceling the data entry process by pressing a Clear key on the keypad 38.

On entering an operate state, the system 10 will cause the display 36 to display a particular set of characters and enable the system to build pressure, if a pump such as pump 64, is in use for example. If no product flow “pulses” are received from the flowmeter 60 by the controller unit 30, the system will assume there is a failure in operation and will terminate injection of additive into the fuel tank or tanks 16a and 16b. When the prescribed volume of additive has been injected into the fuel tank or tanks by the system 10, the controller 30 will also terminate operation of the system and return to the idle state. At the end of every transaction process, the system 10 will monitor the final volume of additive delivered, and automatic adjustment of a dribble volume that flows after the valve 58 is closed for correction of closing time of the valve so that the final volume injected is equal to the preset value. Moreover, in applications involving plural fuel tanks the keypad 38 may be used to select one tank or the other or both for injection of additive by control of valves 23a and 23b, for example. Dribble volume may be minimized if tank selector shut off valves are used, such as valves 23a and 23b, particularly if such valves are disposed directly on the respective tanks 16a and 16b, for example.

The controller 30 may also enter an emergency state when an error condition is detected and valve 58 will be closed and pump 64, if used, deenergized. Possible errors that can be detected are a parameter check error, a flow rate through the module 56 that is too high, excessive dribble after shut-off of the valve 58, no pressure in the additive tank 40 (if a pressurized tank setup is being utilized), insufficient additive in the tank, unauthorized additive flow when flow has not been commanded, as measured by the flowmeter 60, when the transaction log of the controller 32 has reached a maximum number of entries, a failure of an interlock or a handshaking process of the system, and too many errors in system operation.

Dispensing of additive by the system 10 can be temporarily halted by pressing a Stop key on the keypad 38. Typically, the system controller 30 will have a timeout feature which will only allow the system to remain the temporary stop state for a predetermined period. However, pressing a Clear or Enter key on the keypad 38 may be provided for causing the timer to be restarted.

The system 10 may be calibrated by a preset set of keystrokes including entry of a calibrate password via the keypad 38 causing the microcontroller 32 to enter the calibrate mode. In the calibrate mode, the system 10 may be operated to dispense a predetermined amount of additive into a measuring container, not shown, to verify calibration of the flowmeter 60, for example. Still further, the system 10 may be caused to enter a statistics/parameter state and a diagnostic state, both of which may be entered from an idle state by way of the keypad 38 and a suitable password or PIN number.

Those skilled in the art will recognize from the foregoing description that a particularly advantageous fuel additive injection system is provided by the present invention. The system 10 may be completely self-contained and mountable onboard a motor vehicle, marine vessel or a stationary power generation unit, for example. The system 10, including the microcontroller 32, together with the display 36 and the keypad 38 provides for error checking and alarm generation as well as calibration of the flowmeter 60. The system 10 may also, as mentioned above, be adapted for use with equipment that does not include a source of pressure air for providing flow of additive to the fuel tanks. The system 10 may be easily adapted for various power sources, such as 12 volt or 24 volt DC power. The controller 30 may be programmed to require password protection to provide for access to certain features and parameter displays. The system 10 may be selected for calculation and display of additive injection rates, such as parts per million (PPM) or ounces per predetermined number of gallons of fuel. Still further, the system 10 provides for totalizing dispensed additive, the number of transactions and unauthorized flow. The system 10 further may require a personal identification number (PIN) entry for operator (driver) identification as well as, possibly, vehicle (truck or marine vessel) identification. Still further, the system 10 may be capable of determining the amount of additive in the tank 40 by the tank level sensor 51 or calculated from the amount added to the tank and the amount dispensed, the amount added being input via the keypad 38, for example. Of course, the system 10 is also capable of monitoring the pressure in tank 40 at all times thanks to the pressure sensor/gauge 48 which is operable to produce a signal to the controller 30.

The fabrication and operation of the fuel additive injection system 10 is believed to be within the purview of one skilled in the art based on the foregoing description. Although a preferred embodiment of the invention has been described in detail, those skilled in the art will also recognize that various substitutions and modifications may be made to the system without departing from the scope and spirit of the appended claims.

What is claimed is:

1. A fuel additive injection system for adding fuel additive to a quantity of fuel stored in at least one fuel tank, said fuel tank being one of carried onboard and operably connected to one of a motor truck, a marine vessel and a stationary engine-driven apparatus, said injection system including:
an additive supply tank for containing a quantity of fluid fuel additive;
a conduit interconnecting said additive supply tank with said fuel tank and including a remotely controllable shut-off valve interposed therein;
a flowmeter interposed in said conduit; and
a controller operably connected to said flowmeter and said shut-off valve, said controller including a programmable microcontroller, a visual display and a user interface to said microcontroller for causing said system to enter a predetermined state, one of said states being the dispensing of a predetermined quantity of fuel additive from said additive supply tank to said fuel tank.

2. The system set forth in claim 1 including:
a source of pressure air operably connected to said additive supply tank for pressurizing said additive supply tank to provide for flow of additive from said additive supply tank through said conduit to said fuel tank.

3. The system set forth in claim 2 including:
a pressure air conduit connected to said additive supply tank and a pressure regulator interposed in said pressure air conduit for selecting a predetermined pressure in said additive supply tank.

4. The system set forth in claim 3 including:
a pressure sensor operably connected to said additive supply tank and to said controller for monitoring the air pressure in said additive supply tank.

5. The system set forth in claim 1 including:
a motor driven pump operably connected to said additive supply tank and to said conduit for delivering additive fluid from said additive supply tank to said conduit upstream of said shut-off valve.

6. The system set forth in claim 1 including:
an additive fluid quantity sensor disposed for measuring additive fluid quantity in said additive supply tank, said fluid quantity sensor being operably connected to said controller.

7. The system set forth in claim 6 including:
an enclosure including said additive supply tank, said shut-off valve, said flowmeter and said controller disposed in said enclosure.

8. The system set forth in claim 1 including:
remotely controllable shutoff valves operably connected to said controller and to conduits leading to multiple fuel tanks for selecting a fuel tank for which additive is to be injected.

9. A method of adding a fluid fuel additive to an onboard fuel tank of a motor vehicle, said method including the steps of:
providing an additive injection system including an additive supply tank, a conduit interconnecting said supply tank with said fuel tank, a flowmeter interposed in said conduit, a shutoff valve interposed in said conduit and a controller operably connected to said flowmeter and said shutoff valve, said controller including a programmable microcontroller, a visual display and a user interface operably connected to said microcontroller;
causing said display to prompt a user to enter a value for a quantity of fuel that has been placed in said fuel tank using said interface;
causing said system to dispense from said supply tank a predetermined quantity of additive to said fuel tank.

10. The method set forth in claim 9 including the step of:
causing said system to display the volume of additive dispensed into said fuel tank.

11. The method set forth in claim 9, including the step of:
causing said system to display the total volume of fuel treated.

12. The method set forth in claim 9 including the steps of:
causing said display to prompt said user to enter an actual distance traversed by said motor vehicle; and
displaying said distance traversed by said display.

13. The method set forth in claim 12, including the step of:
causing said display to display values of the distance driven per quantity unit of fuel consumed since a prior entry in said microcontroller of values of distance driven and fuel added to said fuel tank.

14. The method set forth in claim 9, including the step of:
causing said display to display the distance traveled since the last entry in said microcontroller of values of distance traveled and fuel added into said system.

15. The method set forth in claim 9, including the step of:
causing said display to display values of additive injection quantity per unit volume of fuel being dispensed by said system into said fuel tank.

16. The method set forth in claim 9, including the step of:
causing said controller to change a rate of injection of additive per unit volume of fuel placed in said fuel tank.

17. The method set forth in claim 9, including the step of:
causing said controller to open a control valve disposed in said conduit based on selection of a fuel tank being one of a plurality of fuel tanks.

18. The method set forth in claim 9, including the step of:
requiring a user of said system to enter a password prior to causing said controller to display selected parameters stored in said microcontroller.
